(19) United States
(12) Patent Application Publication
(10) Pub. No.: US 2018/0224077 A1
(43) Pub. Date: Aug. 9, 2018

(54) METHODS AND APPARATUS FOR A MULTI-FUNCTIONAL FOLDING STRAIGHT LIGHT

(71) Applicant: Aixia Bian, Shanghai (CN)

(72) Inventor: Aixia Bian, Shanghai (CN)

(21) Appl. No.: 15/475,658

(22) Filed: Mar. 31, 2017

Related U.S. Application Data
(60) Provisional application No. 62/456,889, filed on Feb. 9, 2017.

(51) Int. Cl. F21L 4/02; F21L 4/08; F21V 23/04; F21V 21/08

(52) U.S. Cl. CPC F21L 4/02; F21L 4/08; F21Y 2115/10; F21V 21/08; F21V 23/0414

(57) ABSTRACT

The invention provides a portable light system which includes a lamp and a charging base. The lamp has an elongated housing with a top end and a bottom end. A forward lighting element is positioned within a forward face of the housing, and a spotlight is positioned on the top end of the housing. A rechargeable battery system is coupled to an inside of the housing and operably connected to and enabling the lighting element to emit light. A charging port on the bottom end of the housing is electrically connected to the battery system. A switch, operable to turn the lighting element and spotlight on and off, and a hook are positioned on a back face of the housing. The base includes a charging plug, which is shaped to be substantially complementary to the charging port; and a support structure with arms adapted to hold the portable lamp.

### CROSS-REFERENCE TO RELATED APPLICATION

This application claims priority to U.S. application Ser. No. 62/456,889, filed on Feb. 9, 2017, the contents of which are incorporated herein in their entirety.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for increasing visibility in hard to reach place like under vehicles. These devices are especially useful in the event of external power loss.

It is an object of this disclosure to provide an improved portable lighting solution that can be carried by a user to provide light in the area they are working as needed.

It is a further object of this disclosure to provide an improved portable lighting solution with a longer lasting power source.

It is a further object of this disclosure to provide an improved portable lighting solution that is dust and water resistant.

### BRIEF SUMMARY OF THE INVENTION

A portable lamp includes an elongated housing with a top end and a bottom end. A forward lighting element is positioned within a forward face of the housing and a spotlight is positioned on the top end of the housing. A battery system is coupled to an inside of the housing and operably connected to and enabling the lighting element to emit light. A switch, operable to turn the lighting element and spotlight on and off, and a hook are positioned on a back face of the housing.

A portable light system includes a lamp and a charging base. The lamp has an elongated housing with a top end and a bottom end. A forward lighting element is positioned within a forward face of the housing, and a spotlight is positioned on the top end of the housing. A rechargeable battery system is coupled to an inside of the housing and operably connected to and enabling the lighting element to emit light. A charging port on the bottom end of the housing is electrically connected to the battery system. A switch, operable to turn the lighting element and spotlight on and off, and a hook are positioned on a back face of the housing. The base includes a charging plug, which is shaped to be substantially complementary to the charging port, and a support structure with arms adapted to hold the portable lamp.

### BRIEF DESCRIPTION OF THE DRAWINGS

FIG. 1 is a perspective view of the portable light and base unit according to the methods of this disclosure.

FIG. 2 is a front view of the portable light and base unit.

FIG. 3 is a back view of the folded portable light and base unit.

FIG. 4 is a left view of the folded portable light and base unit.

FIG. 5 is a right view of the folded portable light and base unit.

FIG. 6 is a top view of the folded portable light and base unit.

FIG. 7 is a bottom view of the folded portable light and base unit.

FIG. 8 is a perspective view of the portable light.

FIG. 9 is a front left perspective view of the portable light with the base stand engaged.

FIG. 10 is a back left perspective view of the portable light with the base stand engaged.

FIG. 11 is a top perspective view of the portable light with the base stand engaged.

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

The terms “light emitting diode” and “LED” are also used in the following description. One of ordinary skill will appreciate that an LED describes a wide variety of two lead semiconductors that emit light by electroluminescence when a voltage differential is applied. LED lights are made in a variety of sizes and typically come in either through-hole or surface mount configurations.

The term “phosphorescence” is also used in the following description. Phosphorescence refers to a mechanism by which a material fluoresces when exposed to radiation. This mechanism is associated with unsuitable energy state transitions in quantum mechanics. A phosphorescence material does not immediately re-emit the radiation it absorbs, but instead absorbed radiation is re-emitted at a lower intensity for up to several hours after the original excitation.

The present application discloses a multi-functional portable folding straight lamp and base. The portable light or lamp includes an elongated housing with a top end and a bottom end. A forward LED lighting element is positioned within a front face of the portable light, and a spotlight is positioned on the top end of the portable light. A switch is positioned on a back face of the housing. A hook is rotably affixed on the back. A phosphorescent material and a reflector are both positioned around the forward lighting element and the spotlight. The base includes a charging port and arms adapted to support the portable light.

The example multi-functional portable lighting apparatus may be powered via replaceable or rechargeable batteries. In some instances, the multi-functional portable lighting apparatus includes a charging port into which a connector of a power source can be inserted to supply power to rechargeable batteries of the multi-functional lighting apparatus. In other instances, the multi-functional portable lighting apparatus includes a receptacle with conductive contacts into which one or more batteries may be inserted for powering the multi-functional lighting apparatus.

In one example situation, the user, when additional lighting is needed as in a power outage or repair task, removes the lamp from the base, which is connected to an external power source, and activates the switch on the portable light to activate the unit. The user can switch between using the forward light, the spotlight, or both. If the user needs his or her hands, the lamp may be hung using rotable hook on its back. After the user is finished, the user can return the lamp to the base to recharge the unit

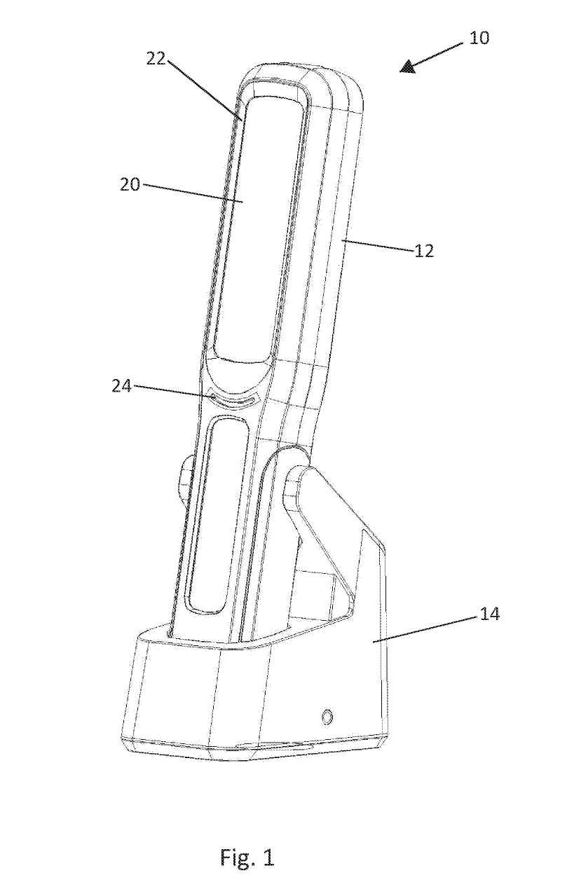

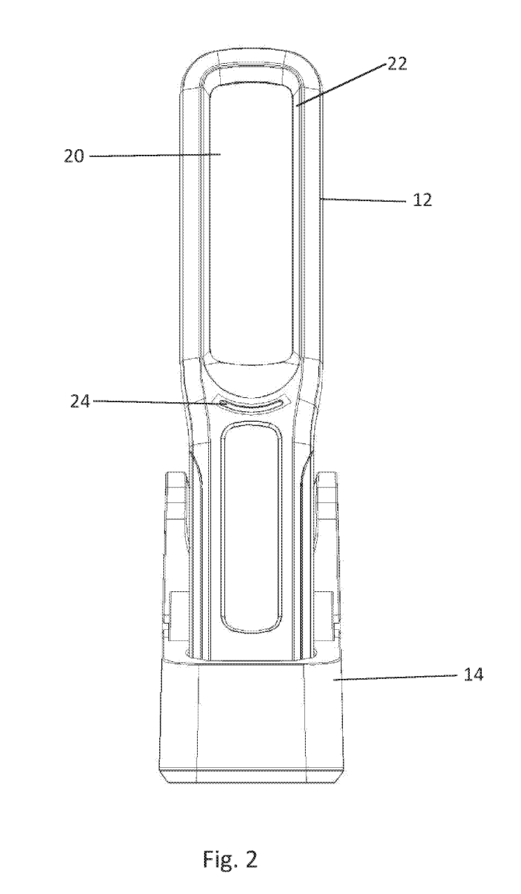

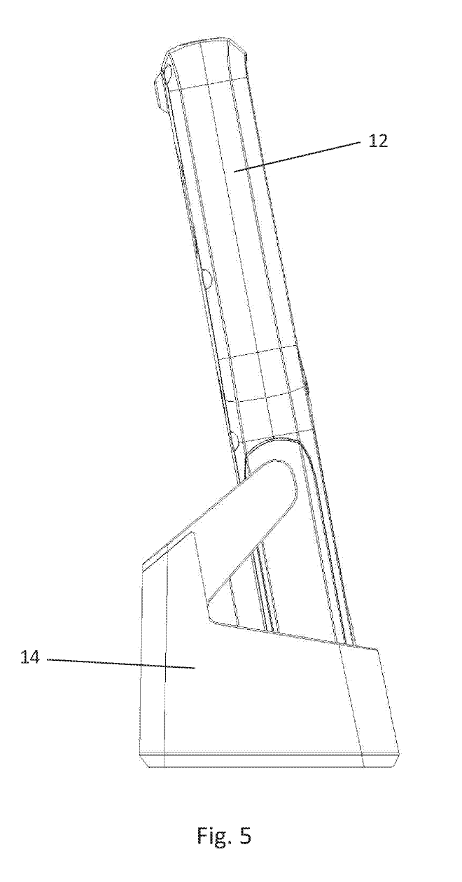

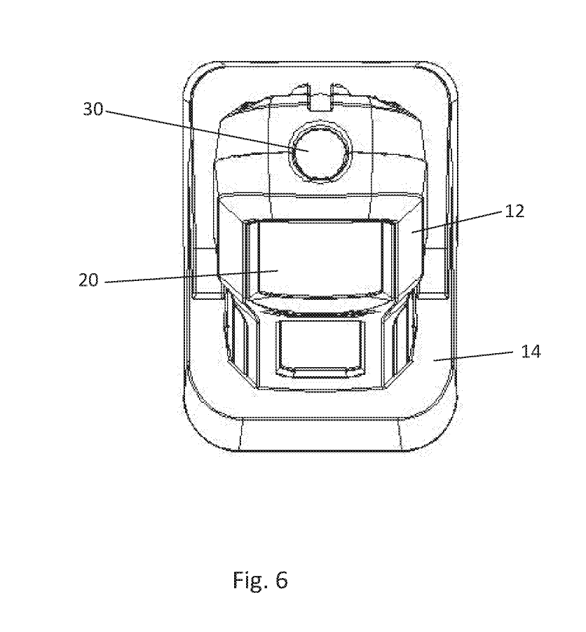

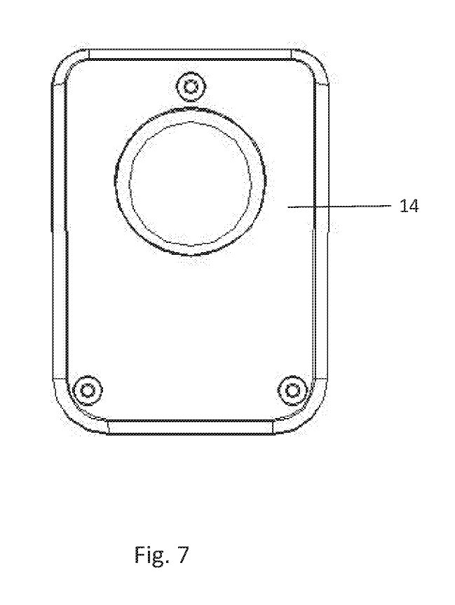

Referring now to FIG. 1, an example of a portable light 10 is shown. Lamp 12 sits on the charging base 14 as shown in FIGS. 1-7. Lamp 12, as shown in FIG. 2, is a solidly constructed light wand with light emitters built into the top and front faces and further containing a lithium ion battery. The lamp 12 also has a charging indicator 24 on the front face. This indicator is a series of LEDs in the shown example. One of ordinary skill in the art would be able to adapt the indicator with other suitable means such as a color changing LED. A switch 42 is included on the rear side of the lamp 12.

The front light emitter on lamp 12 supports a high efficiency COB forward LED 20 used to illuminate surroundings as shown in FIG. 2. The forward LED 20 is a high color rendition index chips on board LED. A reflector 22 is positioned around the LED 20 to better direct the light away from the device. It is contemplated that other light emitting technologies can be used in place of LED 20 including techniques such as arc, incandescent, and florescent bulbs. The reflector 22 is a florescent material which can make it easier to find the lamp 12 in the dark, especially if the device is accidentally turned off.

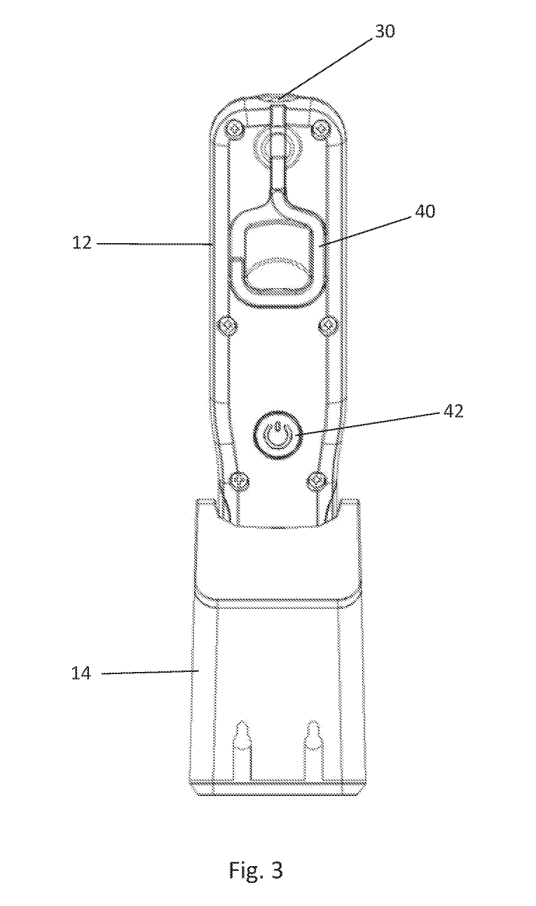

Another light emitter, a spotlight 30, is positioned at the top of the lamp 12 as shown in FIG. 3. The spotlight 30 is also surrounded by a total reflector. The spotlight 30 is a high power surface mounted LED light that can be used as a conventional flashlight when the portable light 10 is extended.

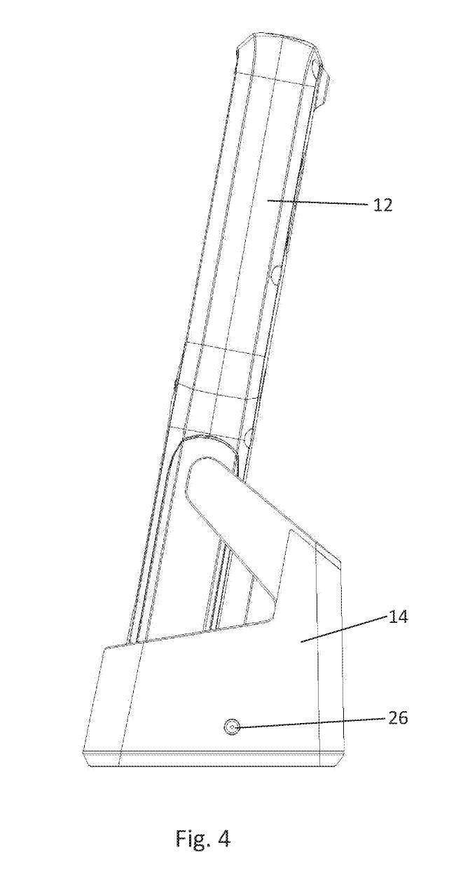

The base portion that comprises charging base 14 includes a charging socket 26 in order to connect the base 14 to external power as shown in FIG. 4. Charging interface 50 on the lamp 12, respectively, are used to ensure a secure and fast connection to between the two parts.

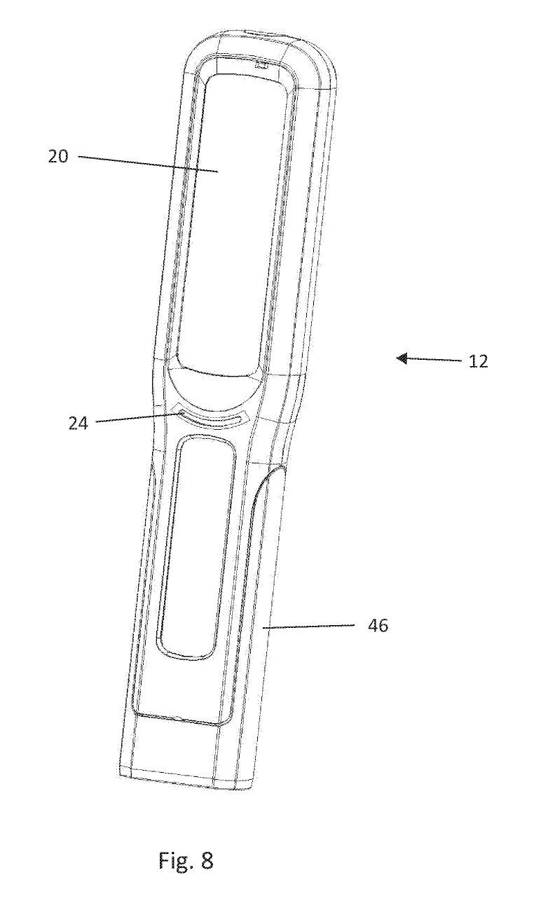

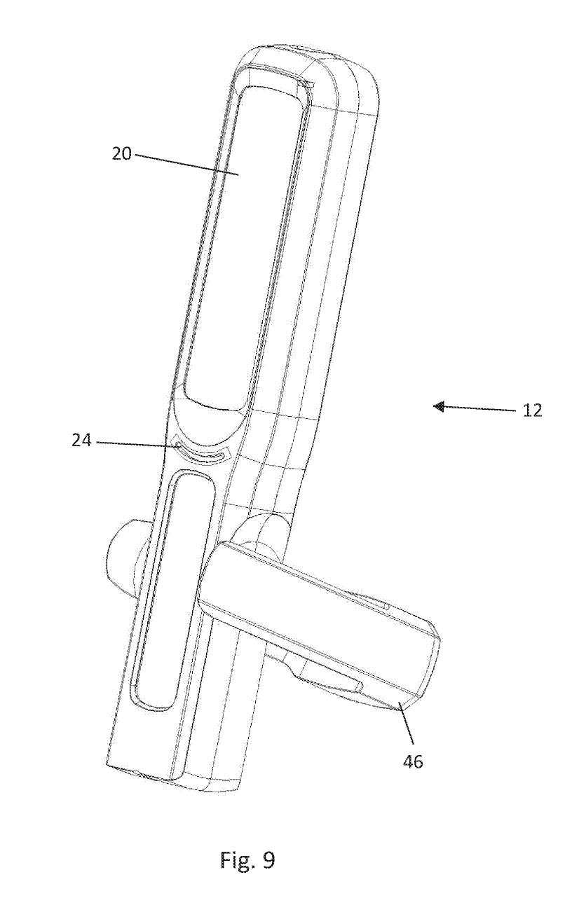

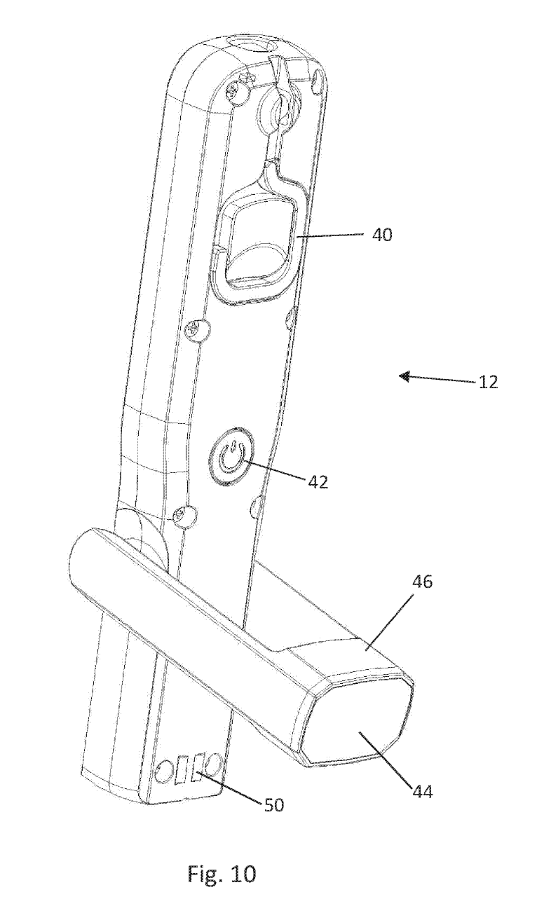

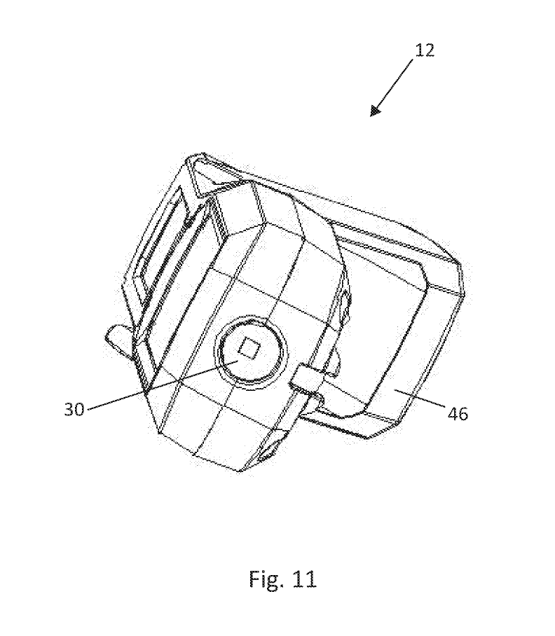

The lamp is shown separately in FIGS. 8-11. The back of the lamp 12 has a rotating bracket 46, as shown in two positions throughout FIGS. 8-9, which can be used as a stand for the lamp 12. The rotating bracket 46 is hingedly connected to the lamp 12 which allows a 180° degree rotation. A magnetic bottom 44 is attached to the bracket 46 to attach the lamp 12 to a ferromagnetic surface. A rotable hanging hook 40 can extend out from the lamp 12 in order to hang the device from any perch.

In use, the lamp 12 is used as a portable light source by the user. It is rechargeable and reusable by virtue of the charging base 14. The strong construction allows product to drop safely from 1.5 meters. The example lamp 12 is rated IP65 for water and dust resistance, which allows use indoors and outdoors. The design of portable light 10 prevents contact and the ingress of any dust. It is also shielded from water such that incidental contact with water will not damage the device.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A portable lamp comprising:
an elongated housing with a top end and a bottom end;
a forward lighting element positioned within a forward face of the housing and a spotlight positioned on the top end of the housing;
a battery system coupled to an inside of the housing and operably connected to and enabling the lighting element to emit light;
a switch, operable to turn the lighting element and spotlight on and off, positioned on a back face of the housing; and
a hook positioned on the back face.

2. A portable lamp of claim 1 wherein the battery system is rechargeable.

3. A portable lamp of claim 2 further comprising a charging port on the bottom end of the housing electrically connected to the battery system.

4. A portable lamp of claim 3 further comprising a base with a charging plug, which is shaped to be substantially complementary to the charging port, and a support structure with arms adapted to hold the portable lamp.

5. The portable light of claim 1 further comprising a phosphorescent material placed proximate to either the forward lighting element or the spotlight.

6. The portable light of claim 5 wherein the phosphorescent material is formed substantially around either the forward lighting element or the spotlight.

7. The portable light of claim 1 further comprising a reflector positioned around either the forward lighting element or the spotlight.

8. The portable light of claim 1 wherein repeated activation of the switch cycles through modes of function of the device where either the forward lighting element or the spotlight are on, both are on, and both are off.

9. The portable light of claim 1 wherein the forward lighting element or the spotlight is a high power SMD LED.

10. The portable light of claim 1 wherein the hook is rotably affixed to the back face of the housing.

11. The portable light of claim 10 wherein the back face of the housing is adapted to receive the hook such that the back face is substantially flat.

12. A portable light system comprising:
a lamp comprising
an elongated housing with a top end and a bottom end;
a forward lighting element positioned within a forward face of the housing and a spotlight positioned on the top end of the housing;
a rechargeable battery system coupled to an inside of the housing and operably connected to and enabling the lighting element to emit light;
a charging port on the bottom end of the housing electrically connected to the battery system;
a switch, operable to turn the lighting element and spotlight on and off, positioned on a back face of the housing; and
a hook positioned on the back face;
a base comprising:
a charging plug shaped to be substantially complementary to the charging port; and
a support structure with arms adapted to hold the portable lamp.

13. The portable light system of claim 12 further comprising a phosphorescent material placed proximate to either the forward lighting element or the spotlight.

14. The portable light system of claim 13 wherein the phosphorescent material is formed substantially around either the forward lighting element or the spotlight.

15. The portable light system of claim 12 further comprising a reflector positioned around either the forward lighting element or the spotlight.

16. The portable light of claim 12 wherein repeated activation of the switch cycles through modes of function of the device where either the forward lighting element or the spotlight are on, both are on, and both are off.

17. The portable light system of claim 12 wherein the forward lighting element or the spotlight is a high power SMD LED.

18. The portable light system of claim 12 wherein the hook is rotably affixed to the back face of the housing.

19. The portable light system of claim 18 wherein the back face of the housing is adapted to receive the hook such that the back face is substantially flat.

20. The portable light system of claim 12 wherein the portable lighting system is adapted to be protected against dust and water.
